(19) United States
(12) Patent Application Publication
(10) Pub. No.: US 2023/0077505 A1
(43) Pub. Date: Mar. 16, 2023

(54) FISHING BAIT MADE OF RECYCLED PLASTIC

(71) Applicant: Colton Storck, Clinton, MS (US)

(72) Inventor: Colton Storck, Clinton, MS (US)

(21) Appl. No.: 17/472,694

(22) Filed: Sep. 13, 2021

(51) Int. Cl. A01K 85/16

(52) U.S. Cl. CPC A01K 85/16

(57) ABSTRACT

Illustrated views of an exemplary fishing lure and a method for making the fishing lure from recycled used fishing lures is presented. The fishing lure is useful for preventing worn or damaged fishing lures from entering the environment and thus causing environmental issues. Also, the fishing lure is useful to reduce costs and oil consumption in the making of the fishing lure.

### FIELD OF THE INVENTION

This invention relates to fishing bait. More particularly, it relates to fishing bait made of recycled materials.

### BACKGROUND

Fishing bait is any substance used to attract and catch fish, e.g., on the end of a fishing hook, or inside a fish trap. Traditionally, nightcrawlers, insects, worms and smaller bait fish have been used for this purpose. Fishermen have also begun using plastic bait and more recently, electronic lures to attract fish.

Studies show that natural baits like croaker and shrimp are more recognized by the fish and are more readily accepted. Which of the various techniques a fisher may choose is dictated mainly by the target species and by its habitat. Bait can be separated into two main categories: artificial baits and natural baits.

Using lures is a popular method for catching predatory fish. Lures are artificial baits designed to resemble the appearance and movement of prey, usually small fish. The lure may require a specialized presentation to impart an enticing action as, for example, in fly fishing. A common way to fish a soft plastic worm is the Texas rig.

The technology used by anglers to catch fish has become increasingly complex in nature. Fishermen no longer rely on the traditional hook and worm approach to attract their game. Instead, a broad range of products have hit the market, designed to aid the fisherman to catch more fish quickly. Of course, the most basic and common of these products is the lure itself. The marketplace has responded with literally tens of thousands of different types of lures. Unfortunately, when damaged or no longer needed, these lures end their life in the water where they can ironically end up killing the fish, so that no one can catch them. They may also end up on piers, docks, and shorelines where they create litter. Finally, even if they are disposed of properly, they contribute to the waste stream and waste natural resources.

Accordingly, and in light of the foregoing, it would be desirable to devise a means by which fishing lures can be recycled to address these concerns. It would be further advantageous if the fishing lures were cost efficient and easy to use.

### BRIEF DESCRIPTION OF THE DRAWINGS

FIG. 1A and FIG. 1B are illustrated views of an exemplary fishing lure.

FIG. 2 is an illustrated visual flow chart to create the fishing lure shown in FIG. 1A and FIG. 1B.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

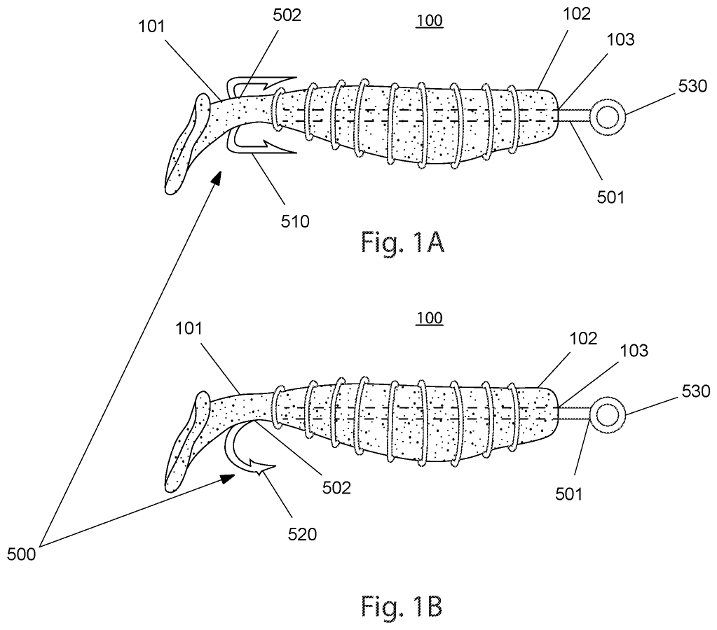

Referring to FIG. 1A and FIG. 1B, illustrated views of an exemplary fishing lure 100 made from recycled fishing lures is presented. The fishing lure 100 is useful for preventing worn or damaged fishing lures from entering the environment and thus causing environmental issues. Also, the fishing lure 100 is useful to reduce costs and oil consumption in the making of the fishing lure 100.

The fishing lure 100 preferably has a length of between two (2) and seven (7) inches, however other lengths are hereby contemplated, including, but not limited to, one (1) inch, ten (10) inches, etc. The fishing lure 100 preferably has a width of between one (1) and three (3) inches, however other widths are hereby contemplated, including, but not limited to, one-half (½) inch, four (4) inches, etc. The fishing lure 100 preferably has a fish-like shape, however other shapes are hereby contemplated, including, but not limited to, worm-shape, cricket-like shape, etc. The fishing lure 100 preferably has a fishing hook 500, however it is hereby contemplated that the fishing lure 100 does not have a fishing hook 500. In FIG. 1B, the fishing hook 500 is preferably a multiple-hook fishing hook 510, however it is hereby contemplated that the fishing hook is a single-hook fishing hook 520. In FIG. 1A, the fishing hook 500 is the multiple-hook fishing hook 510, while in FIG. 1B, the fishing hook 500 is the single-hook fishing hook 520.

The fishing lure 100 is preferably made of a soft plastic material, however other materials are hereby contemplated, including, but not limited to, poly-vinyl chloride (PVC), vinyl, nylon, etc. The fishing hook 500 is made of a metal material. Each of the fishing hooks 500, multiple-hook 520 and single-hook 520, is coupled to an inside 103 of the fishing lure 100. A connection point 530 of the fishing hook 500 is coupled to a first end 501 of the fishing hook 500 and extend from a first end 102 of the fishing lure 100, while one the hook(s) 510, 520 extend from the second end 502 of the fishing lure 100 and extend through the fishing lure 100 near a second end 101 of the fishing lure 100.

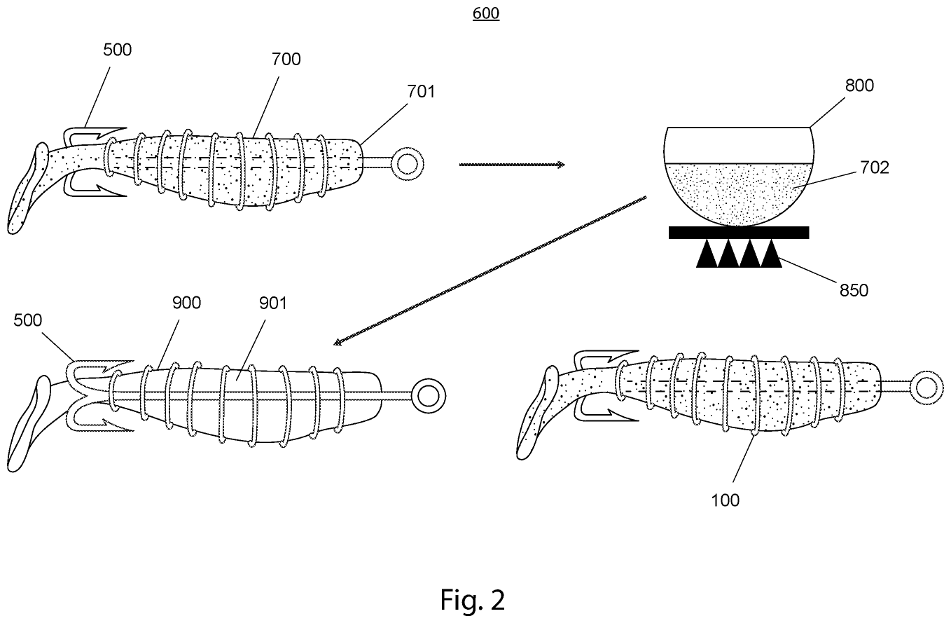

Moving now to FIG. 2, is an illustrated visual flow chart 600 for making the fishing lure 100 shown in FIG. 1A and FIG. 1B is presented.

The flow chart 600 begins with obtaining worn out, damaged or disposed of a used fishing lure 700. The used fishing lure 700 is obtained and if the used fishing lure 700 has a hook 500, it is removed from an interior 701 of the used fishing lure 700.

The used fishing lure 700 is then either chopped, minced, ground or left whole and is placed into a heating receiver 800. The heating receiver 800 may be any type of receiver such as an injection machine, a commercial vat, etc. A heating device 850 is used to heat and melt the used fishing lure 700.

A fishing lure mold 900 is then obtained and the fishing hook 500 is placed into the interior 901 of the fishing lure mold 900. Once the used fishing lure 700 has become a liquid 702, then the liquid 702 is injected, or poured into the fishing lure mold 900. The fishing lure mold 900 is then set aside to set and cool.

Once the liquid 702 has cooled in the fishing lure mold 900, then fishing lure 100 is removed from the fishing lure mold 900. The fishing lure mold 900 is reusable.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method for making a fishing lure, the method comprising:
obtaining a used fishing lure;
placing the used fishing lure into a heating device; applying a heat to the heating device;
melting the used fishing lure into a liquid;
preparing a fishing lure mold;
injecting, or pouring, the liquid into the fishing lure mold; and
when the liquid has cooled, removing the fishing lure mold to obtain the fishing lure.

2. The method of claim 1, wherein the fishing hook is a multiple-hook fishing hook.

3. The method of claim 1, wherein the fishing hook is a single-hook fishing hook.

4. The method of claim 1, wherein the fishing lure is a length of between two (2) and seven (7) inches.

5. The method of claim 1, wherein the fishing lure is a width between one (1) and three (3) inches.

6. The method of claim 1, wherein the fishing lure resembles a fish.

8. The method of claim 1, wherein the fishing lure is made of a soft plastic material.
